(19) United States
(12) Patent Application Publication
(10) Pub. No.: US 2026/0287897 A1
(43) Pub. Date: Sep. 24, 2026

(54) IMAGE DISPLAY DEVICE AND IMAGE DISPLAY METHOD

(71) Applicant: SONY GROUP CORPORATION, Tokyo (JP)

(72) Inventor: Akira YOSHIKAIE, Tokyo (JP)

(73) Assignee: SONY GROUP CORPORATION, Tokyo (JP)

(21) Appl. No.: 19/490,838

(22) PCT Filed: Jun. 12, 2024
(86) PCT No.: PCT/JP2024/021270

§ 371 Date: Dec. 5, 2025

(30) Foreign Application Priority Data
Jun. 23, 2023 (JP) 2023-103295

(51) Int. Cl. G02B 27/01; G02B 27/00

(52) U.S. Cl. CPC G02B 27/0172; G02B 27/0093; G02B 27/0179; G02B 2027/0112

(57) ABSTRACT

The purpose of the present invention is to achieve both expansion of a free focus range and improvement in image resolution. An image display device of the present invention includes: a plurality of light source units; a scanning unit that scans each of emitted light beams emitted from each of the light source units; a relay optical system that relays the light beams scanned by the scanning unit to form an image on a retina of an observer and allows the observer to visually recognize the image; and a control unit that controls driving of each of the light source units, and divergence angles of the respective emitted light beams are different.

### TECHNICAL FIELD

The technology according to the present disclosure (hereinafter, also referred to as the “present technology”) relates to an image display device and an image display method.

### BACKGROUND ART

Conventionally, a retinal projection display has been developed in which an image is projected on a retina of an observer to allow the observer to visually recognize the image. Since the image is projected on the retina of the observer, the observer can clearly and visually recognize a high-resolution image even if the observer moves a crystalline lens to change a focus to some extent. Note that a range in which an observer can clearly and visually recognize a high-resolution image even if the observer changes a focus is referred to as a free focus range.

Various technologies have been developed as a light source for generating this image. For example, Patent Document 1 describes “a light emitting device that realizes a light emitting point pitch and a light emitting position that cannot be achieved by a laser diode alone and can be downsized”.

### CITATION LIST

### Patent Document

Patent Document 1: Japanese Patent Application Laid-Open No. 2022-169006

### SUMMARY OF THE INVENTION

### Problems to be Solved by the Invention

When an image is observed by using a retinal projection display, it is preferable that a high-resolution image can be observed in a wide free focus range.

However, in the conventional retinal projection display, there is room for improvement in achieving both expansion of a free focus range and improvement in image resolution.

Therefore, a main object of the present technology is to provide an image display device and an image display method capable of achieving both expansion of a free focus range and improvement in image resolution.

### Solutions to Problems

The present technology provides an image display device including:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, in which
divergence angles of the respective emitted light beams are different.

The control unit may switch a free focus range by controlling the driving of each of the light source units on the basis of a display position of the image.

The plurality of light source units may include at least a first light source unit, a second light source unit, and a third light source unit, and
when a first free focus range determined by the first light source unit and a second free focus range determined by the second light source unit are switched with a predetermined threshold,
a third free focus range determined by the third light source unit may include the predetermined threshold.

The arrangement positions of the respective light source units may be different.

The arrangement positions of the respective light source units may be different in an optical axis direction of the emitted light.

An adjustment unit that adjusts the divergence angles of the emitted light beams and emits the emitted light beams to the relay optical system may be further included.

Exit pupils of respective light beams incident on a pupil of the observer may be substantially the same.

A plurality of optical waveguides that guides the light beams emitted from the respective light source units may be further included.

Positions of light emitting ends of the respective optical waveguides may be different in an optical axis direction of the emitted light.

The plurality of optical waveguides may be formed in a planar lightwave circuit,
the planar lightwave circuit may have light emitting surfaces including the light emitting ends, and
the light emitting surfaces may be formed in a direction substantially orthogonal to the optical axis direction of the emitted light, and the respective light emitting ends may be formed on different planes.

The plurality of light source units may include:
a first light source unit that emits emitted light in a first wavelength band,
a second light source unit that emits emitted light in a second wavelength band, and
a third light source unit that emits emitted light in a third wavelength band.

The first wavelength band may be a wavelength band corresponding to red,
the second wavelength band may be a wavelength band corresponding to green, and
the third wavelength band may be a wavelength band corresponding to blue.

The divergence angles of the respective emitted light beams may be different according to a wavelength band of each of the emitted light beams.

A multiplexing unit that multiplexes the respective emitted light beams emitted from the respective light source units and emits the multiplexed light beams to the relay optical system may be further included.

The relay optical system may include an adjustment element that adjusts the divergence angle of the emitted light, and
the adjustment element may be movable on the basis of a display position of the image. An optical element arranged in front of an eye of the observer may be further included, and the optical element may transmit a part of light incident on the optical element, reflect a part of the light, and emit the light to a pupil of the observer.

The optical element may be a diffractive element.

The image display device may be worn on a head of the observer.

Furthermore, the present technology provides an image display method of an image display device including:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, in which
divergence angles of the respective emitted light beams are different.

According to the present technology, it is possible to achieve both expansion of a free focus range and improvement in image resolution. Note that effects described herein are not necessarily restrictive, and any of the effects described in the present disclosure may be exhibited.

### BRIEF DESCRIPTION OF DRAWINGS

FIG. 1 is a schematic diagram illustrating a configuration example of an image display device 100 according to one embodiment of the present technology.

FIG. 2 is a graph illustrating a correlation between a size of an on-retina spot and a free focus range.

FIG. 3 is a schematic diagram illustrating a configuration example of a light source unit 11 according to one embodiment of the present technology.

FIG. 4 is a schematic diagram illustrating a configuration example of the light source unit 11 according to one embodiment of the present technology.

FIG. 5 is a graph illustrating a correlation between a size of an on-retina spot and a free focus range.

FIG. 6 is a schematic diagram illustrating a configuration example of the light source unit 11 according to one embodiment of the present technology.

FIG. 7 is a schematic diagram illustrating a configuration example of the light source units 11 according to one embodiment of the present technology.

FIG. 8 is a schematic diagram illustrating a state in which an image is formed on a retina of an observer.

FIG. 9 is a schematic diagram illustrating a configuration example of the image display device 100 according to one embodiment of the present technology.

FIG. 10 is a schematic diagram illustrating a configuration example of the image display device 100 according to one embodiment of the present technology.

FIG. 11 is a schematic diagram illustrating a configuration example of the image display device 100 according to one embodiment of the present technology.

FIG. 12 is a schematic diagram of an observer wearing the image display device 100 according to one embodiment of the present technology on a head as viewed from the front.

FIG. 13 is a graph illustrating a correlation between a size of an on-retina spot and a free focus range.

### MODE FOR CARRYING OUT THE INVENTION

Hereinafter, preferred embodiments for carrying out the present technology will be described with reference to the drawings. Note that the embodiments to be described below each illustrates an example of a representative embodiment of the present technology, and the scope of the present technology is not limited by this. Furthermore, in the present technology, any of the following examples and modifications thereof can be combined.

In the following description of the embodiments, a configuration is described in some cases by using terms with “substantially” such as substantially parallel or substantially orthogonal. For example, “substantially parallel” means not only being completely parallel, but also includes being substantially parallel, that is, a state shifted by, for example, about several percent from the completely parallel state. This similarly applies to other terms with “substantially”. Furthermore, each drawing is a schematic diagram and is not necessarily strictly illustrated. A scale of the drawings is exaggerated to facilitate understanding of the technical features. Therefore, it should be noted that a scale of the drawings and a scale of an actual device are not necessarily the same.

Unless otherwise specified, in the drawings, “upper” means an upward direction or an upper side in the drawing, “lower” means a downward direction or a lower side in the drawing, “left” means a leftward direction or a left side in the drawing, and “right” means a rightward direction or a right side in the drawing. Furthermore, in the drawings, the same or equivalent elements or members are denoted by the same reference signs, and redundant description will be omitted.

The description will be given in the following order.
1. First Embodiment of Present Technology (Example 1 of Image Display Device)
(1) Overview
(2) Configuration of Image Display Device
(3) Arrangement Position of Light Source Unit
2. Second Embodiment of Present Technology (Example 2 of Image Display Device)
3. Third Embodiment of Present Technology (Example 3 of Image Display Device)
4. Fourth Embodiment of Present Technology (Example 4 of Image Display Device)
5. Fifth Embodiment of Present Technology (Example 5 of Image Display Device)
6. Sixth Embodiment of Present Technology (Example 6 of Image Display Device)
7. Seventh Embodiment of Present Technology (Example 7 of Image Display Device)
8. Eighth Embodiment of Present Technology (Example 8 of Image Display Device)
9. Ninth Embodiment of Present Technology (Example of Image Display Method)

### 1. First Embodiment of Present Technology (Example 1 of Image Display Device)

### [(1) Overview]

When light incident on a pupil reaches a retina, a photoreceptor cell inside the retina senses the light and converts the light into a nerve signal. This nerve signal is sent through an optic nerve to a brain, where the brain interprets the signal to enable us to recognize the scenes and objects we see.

In order to allow the observer to observe an image, a retinal projection display projects the image onto the retina of the observer and forms an image on the retina. An area where the image is formed on the retina is referred to as an on-retina spot. The smaller the size of this on-retina spot, the more the observer can observe a higher resolution image.

However, the smaller the size of the on-retina spot, the narrower a free focus range.

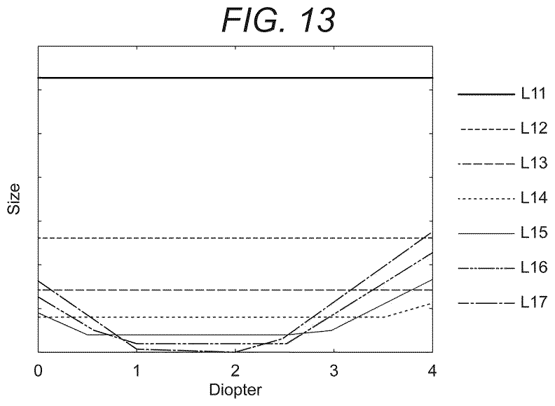

This point will be described with reference to FIG. 13. FIG. 13 is a graph illustrating a correlation between the size of the on-retina spot and the free focus range. The vertical axis indicates the size of the on-retina spot. The horizontal axis indicates a diopter (D) which is a value corresponding to an adjustment distance of an eyeball.

Even if a value of the diopter changes, a range in which the size of the on-retina spot is constant is the free focus range. In this free focus range, the observer can visually recognize a high-resolution image even if the observer changes a focus by adjusting the eyeball. In this drawing, a range substantially parallel to the horizontal axis is the free focus range.

When a light flux for allowing the observer to visually recognize an image is projected on the pupil of the observer, a diameter of the light flux is referred to as an exit pupil. The exit pupil may be, for example, 0.5 mm, 1.0 mm, 1.5 mm, or the like. Respective lines (L11 to L17) in this graph have different exit pupil values. The light flux is light having an arbitrary object point (for example, a light emitting point of the light flux) and an arbitrary exit pupil (for example, L11 to L17) on the pupil. A relationship such as a narrow or wide free focus range with respect to the exit pupil and a small or large size of the on-retina spot does not depend on a position of the object point. The light flux indicated by the line L11 has the smallest exit pupil, and the light flux indicated by the line L17 has the largest exit pupil. The larger the exit pupil, the smaller the size of the on-retina spot, and the observer can visually recognize a higher resolution image.

On the other hand, as indicated in this graph, the larger the exit pupil, the narrower the free focus range. For example, a free focus range when the light flux indicated by the line L17 is projected onto the retina is narrower than a free focus range when the light flux indicated by the line L11 having a smaller exit pupil is projected onto the retina.

As described above, as the exit pupil becomes larger, the size of the on-retina spot becomes smaller, and the observer can observe a higher resolution image. On the other hand, as the exit pupil becomes larger, the free focus range becomes narrower, and if the observer changes a focus by adjusting the eyeball even slightly, the image is not in focus and appears unclear.

Therefore, in the conventional technology, it is difficult to achieve both expansion of the free focus range and improvement in the image resolution. Therefore, the present technology provides an image display device that can achieve both. Specifically, the present technology provides an image display device including: a plurality of light source units; a scanning unit that scans respective emitted light beams emitted from the respective light source units; a relay optical system that relays the light beams scanned by the scanning unit to form an image on a retina of an observer and allows the observer to visually recognize the image; and a control unit that controls driving of each of the light source units, in which divergence angles of the emitted light beams are different.

### [(2) Configuration of Image Display Device]

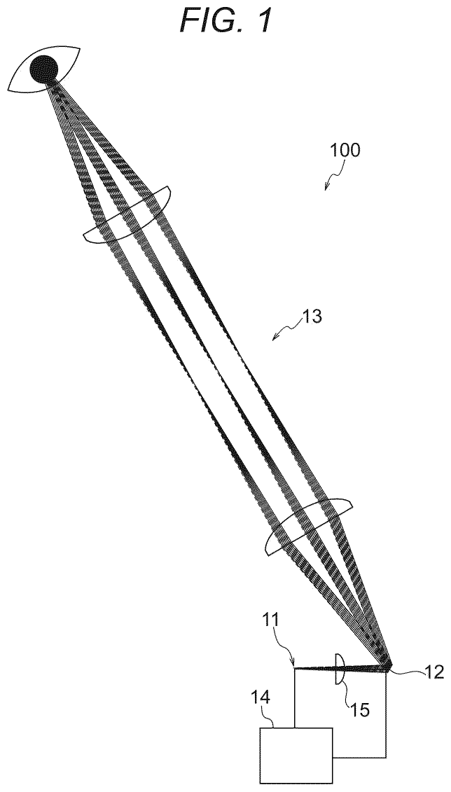

A configuration example of an image display device according to one embodiment of the present technology will be described with reference to FIG. 1. FIG. 1 is a schematic diagram illustrating a configuration example of an image display device 100 according to one embodiment of the present technology. As illustrated in FIG. 1, the image display device 100 includes at least a plurality of light source units 11, a scanning unit 12, a relay optical system 13, and a control unit 14.

As the light source unit 11, for example, a laser light source can be applied. The laser has high light luminance and constant wavelength characteristic, and thus is suitable for projecting a clear and bright image on the retina. Features of the laser include a high contrast ratio, a wide color gamut, and a high resolution.

Alternatively, for example, a light emitting diode (LED) may be applied as the light source unit 11. The LED has low power consumption and can provide rich color representation and high luminance.

The scanning unit 12 scans respective emitted light beams emitted from the respective light source units 11 to form an image. For example, a micro-electro-mechanical systems (MEMS) mirror can be used as the scanning unit 12. The MEMS mirror is a mirror having a fine mechanical structure, and can slightly vibrate and rotate the mirror by using an electric signal. With this arrangement, the emitted light beams can be scanned to form an image.

An element configuring the scanning unit 12 is not limited to the MEMS mirror, and may be, for example, a galvanometer. The galvanometer is a device that scans emitted light by slightly vibrating a mirror using an electric signal. By controlling a position of the mirror, a direction of the light can be changed, and the emitted light can be scanned.

The relay optical system 13 relays the light beams scanned by the scanning unit 12 to form an image on the retina of the observer and allows the observer to visually recognize the image. The relay optical system 13 includes a plurality of optical elements. The respective optical elements relay the light beams scanned by the scanning unit 12 to form an image on the retina of the observer, allowing the observer to visually recognize the image.

The control unit 14 controls driving of each light source unit 11. Specifically, the control unit 14 controls turning on and off of each light source unit 11. Alternatively, the control unit controls driving of the scanning unit 12. As the control unit 14, for example, a microcontroller, a driver integrated circuit (IC), a signal generation circuit, or the like can be used.

At this time, it is preferable that divergence angles of the respective emitted light beams emitted from the respective light source units 11 are different. The divergence angle is an angle representing how much the emitted light emitted from the light source unit 11 travels while spreading in the space. The emitted light emitted from the light source unit 11 travels while spreading at a certain angle. The divergence angle is used as an index for quantifying how much the emitted light travels while spreading.

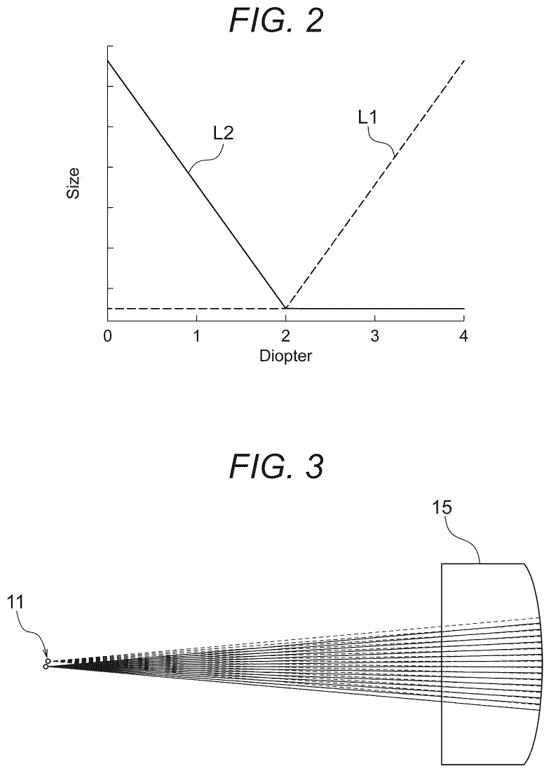

Since the divergence angles of the respective emitted lights are different, the image display device 100 can set a plurality of free focus ranges. This point will be described with reference to FIG. 2. FIG. 2 is a graph illustrating a correlation between a size of an on-retina spot and a free focus range. The vertical axis indicates the size of the on-retina spot. The horizontal axis indicates a diopter (D) which is a value corresponding to an adjustment distance of an eyeball.

When the plurality of light source units 11 included in the image display device 100 includes a first light source unit and a second light source unit, a first line L1 in the graph indicates a characteristic of emitted light emitted from the first light source unit. A second line L2 indicates a characteristic of emitted light emitted from the second light source unit.

A divergence angle of the emitted light emitted from the first light source unit indicated by the first line L1 and a divergence angle of the emitted light emitted from the second light source unit indicated by the second line L2 are different. Therefore, a free focus range (0 to 2 D) determined by the first light source unit indicated by the first line L1 and a free focus range (2 to 4 D) determined by the second light source unit indicated by the second line L2 are different.

Note that exit pupils of the respective light beams incident on the pupil of the observer are substantially the same.

The control unit 14 (see FIG. 1) controls driving of each light source unit 11. For example, when the control unit 14 turns on the first light source unit, the free focus range indicated by the first line L1 is obtained. When the control unit 14 turns on the second light source unit, the free focus range indicated by the second line L2 is obtained. By switching the free focus range in this manner, light having a wide free focus range and a large exit pupil (small size of the on-retina spot) can be projected on the retina of the observer. That is, both the expansion of the free focus range and the improvement in image resolution can be achieved. Note that this effect is similarly provided in other embodiments described later. Therefore, in other embodiments, repeated description thereof may be omitted.

It is preferable that the exit pupils of the respective light beams incident on the pupil of the observer are substantially the same. With this arrangement, it is possible to suppress a change in resolution due to switching of the free focus range, and thus, discomfort given to the observer is reduced.

A reference for switching the free focus range is not particularly limited, but for example, the control unit 14 can switch the free focus range by controlling the driving of each light source unit on the basis of a display position of the image. To describe by taking this graph as an example, the first light source unit indicated by the first line L1 emits light so as to cause the observer to observe an object point at which a value of the diopter on the horizontal axis is 1.4 D. The second light source unit indicated by the second line L2 emits light so as to cause the observer to observe an object point at which a value of the diopter on the horizontal axis is 3.4 D. That is, each of 1.4 D and 3.4 D is a display position of the image. The control unit 14 can switch the free focus range by controlling the driving of each light source unit on the basis of the display position of the image. With this arrangement, both the expansion of the free focus range and the improvement in image resolution can be achieved.

As illustrated in FIG. 1, the image display device 100 may further include an adjustment unit 15. The adjustment unit 15 can adjust a divergence angle of each emitted light emitted from each light source unit 11 and emit the light to the relay optical system 13.

The adjustment unit 15 may have, for example, a collimating optical system. The collimating optical system can adjust a divergence angle by converting emitted light emitted from the light source unit 11 into substantially parallel light. More specifically, the collimating optical system may include a collimator lens, a fiber collimator, a prism, a mirror, and the like.

Furthermore, although not illustrated, for example, the relay optical system 13 may include the adjustment unit 15. In this case, the relay optical system 13 can adjust a divergence angle of light while relaying the light scanned by the scanning unit 12.

### [(3) Arrangement Position of Light Source Unit]

Means for making divergence angles of respective emitted lights emitted from the respective light source units 11 different is not particularly limited. An example of the means for making the divergence angles different will be described with reference to FIG. 3. FIG. 3 is a schematic diagram illustrating a configuration example of the light source unit 11 according to one embodiment of the present technology. As illustrated in FIG. 3, since arrangement positions of each of the light source units 11 are different, an optical path difference occurs in each of the emitted light beams emitted from each of the light source units 11. Therefore, the divergence angles of the respective emitted light beams can be made different.

At this time, a direction in which the arrangement positions of the light source units 11 are made different is not particularly limited, but it is preferable that the arrangement positions of the respective light source units 11 are different in an optical axis direction (left-right direction in the drawing) of the emitted light. With this arrangement, the space in the image display device 100 can be effectively used, which contributes to downsizing of the image display device 100.

Furthermore, a number of light source units 11 is not particularly limited. In the configuration example, the number of the light source units 11 is two, but may be three or more. Increasing the number of light source units 11 may increase cost, but there is a possibility that a free focus range will be further expanded, and an image will be clearer. As described above, the larger the exit pupil, the higher the resolution of the image, while the narrower the free focus range. By increasing the number of light source units 11, the free focus range can be expanded while allowing the observer to visually recognize a high-resolution image.

The above contents described for the image display device according to the first embodiment of the present technology can be applied to other embodiments of the present technology as long as there is no technical contradiction.

### 2. Second Embodiment of Present Technology (Example 2 of Image Display Device)

As described above, the control unit 14 can switch the free focus range by controlling the driving of each light source unit 11. At this time, for example, due to an event such as a sudden change in the display position of the image or a failure in sensing of the eyeball, there is a possibility that necessary switching does not occur or unnecessary switching occurs.

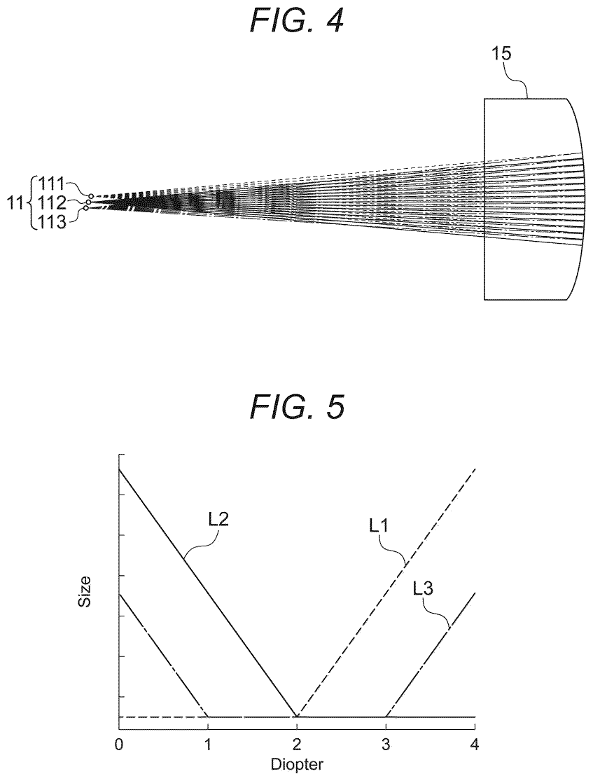

Therefore, for example, when the first light source unit and the second light source unit are configured, it is preferable to further include a third light source unit for smoothly switching the free focus range. This point will be described with reference to FIGS. 4 and 5. FIG. 4 is a schematic diagram illustrating a configuration example of the light source unit 11 according to one embodiment of the present technology. FIG. 5 is a graph illustrating a correlation between the size of the on-retina spot and the free focus range.

As illustrated in FIG. 4, in this configuration example, the plurality of light source units includes at least a first light source unit 111, a second light source unit 112, and a third light source unit 113. Since the arrangement positions of each of the first light source unit 111, the second light source unit 112, and the third light source unit 113 are different, an optical path difference occurs in each of the emitted light beams. Therefore, the divergence angles of the respective emitted light beams can be made different. It is preferable that the arrangement positions of each of the first light source unit 111, the second light source unit 112, and the third light source unit 113 are different in the optical axis direction (left-right direction in the drawing) of the emitted light.

Since the divergence angles of the respective emitted light beams are different, as illustrated in FIG. 5, a first free focus range determined by the first light source unit 111 indicated by a first line L1, a second free focus range determined by the second light source unit 112 indicated by a second line L2, and a third free focus range determined by the third light source unit 113 indicated by a third line L3 are different from each other. In this graph, the first free focus range is a range of 0 to 2 D, the second free focus range is a range of 2 to 4 D, and the third free focus range is a range of 1 to 3 D.

The control unit 14 (see FIG. 1) switches the first free focus range determined by the first light source unit 111 and the second free focus range determined by the second light source unit 112 with a predetermined threshold. In this graph, the threshold is set to 2 D. When the value of the diopter is 2 D or more, the control unit 14 turns on the first light source unit 111. When the value of the diopter is less than 2 D, the control unit 14 turns on the second light source unit 112. In this way, the free focus range can be switched. Note that this threshold is not limited to 2 D, and can be set to an appropriate value according to the situation.

At this time, it is preferable that the third free focus range determined by the third light source unit 113 indicated by the third line L3 includes this predetermined threshold. In this graph, since the threshold is 2 D, the third free focus range (1 to 3 D) includes this threshold.

With this arrangement, the free focus range can be stably switched. For example, when a value of the diopter on the horizontal axis is around OD, the first light source unit 111 indicated by the first line L1 is turned on. When the value of the diopter gradually increases and approaches the threshold 2 D, the third light source unit 113 indicated by the third line L3 is turned on. Even if the value of the diopter further increases and becomes slightly larger than the threshold, the third light source unit 113 remains turned on. When the value of the diopter becomes considerably larger than the threshold, the second light source unit 112 indicated by the second line L2 is turned on. In this way, even if the value of the diopter slightly rises or falls from the threshold, the free focus range is not switched. Therefore, robustness of the image display device 100 is improved.

The above contents described for the image display device according to the second embodiment of the present technology can be applied to other embodiments of the present technology as long as there is no technical contradiction.

### 3. Third Embodiment of Present Technology (Example 3 of Image Display Device)

In order to downsize the image display device, it is preferable that the respective light source units 11 are arranged close to each other. However, since each light source unit 11 has a finite size, there is a limit to proximity. Furthermore, when the respective light source units 11 are extremely brought close to each other, there is a possibility that the emitted light beams emitted from the respective light source units 11 interfere with each other.

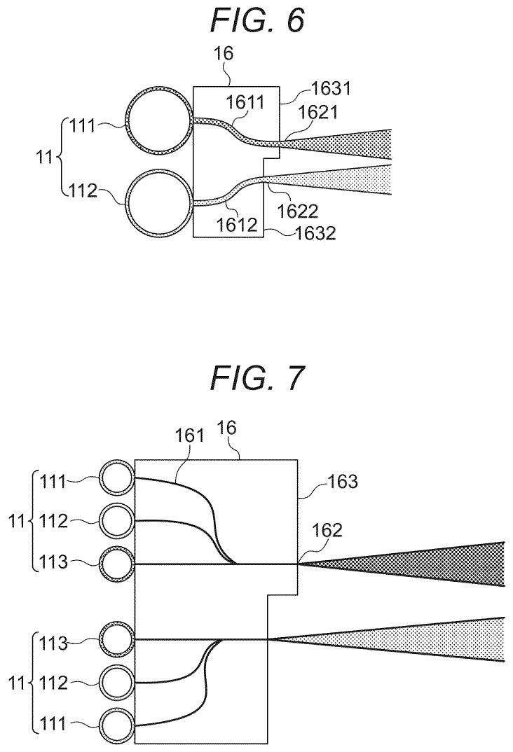

Therefore, the image display device 100 preferably includes a plurality of optical waveguides that guides the light beams emitted from the respective light source units 11. This point will be described with reference to FIG. 6. FIG. 6 is a schematic diagram illustrating a configuration example of the light source unit 11 according to one embodiment of the present technology.

As illustrated in FIG. 6, the image display device 100 includes a plurality of optical waveguides 1611 and 1612 that guides the light beams emitted from the respective light source units 111 and 112. With this arrangement, since the respective light source units 111 and 112 can be brought as close as possible, it is possible to contribute to downsizing of the image display device 100.

The embodiment of the optical waveguides 1611 and 1612 is not particularly limited, but for example, the optical waveguides 1611 and 1612 may be formed in a planar lightwave circuit (PLC) 16. The planar lightwave circuit 16 is more easily downsized and integrated than an optical fiber or the like, and has an advantage that high reliability and high functionality can be obtained. Furthermore, since the planar lightwave circuit 16 can be mass-produced using a mask optical technology, mass production can be performed at low cost.

The emitted light beams emitted from the respective light source units 111 and 112 are emitted via the respective optical waveguides 1611 and 1612. Since the positions of light emitting ends 1621 and 1622 of each of the optical waveguides 1611 and 1612 are different, an optical path difference occurs in each of the emitted light beams emitted from each of the light emitting ends 1621 and 1622. Therefore, the divergence angles of the respective emitted light beams can be made different.

At this time, the direction in which the positions of the light emitting ends 1621 and 1622 of each of the optical waveguides 1611 and 1612 are made different is not particularly limited, but the positions of the light emitting ends 1621 and 1622 of each of the optical waveguides 1611 and 1612 are preferably different in the optical axis direction (left-right direction in the drawing) of the emitted light. With this arrangement, the space in the image display device 100 can be effectively used, which contributes to downsizing of the image display device 100.

Note that Patent Document 1 (Japanese Patent Application Laid-Open No. 2022-169006) discloses that a normal direction N1 of a light emitting surface 240 is inclined with respect to an optical axis direction 32 of a lens 30. Due to this inclination, distances (optical path lengths) from the respective light emitting ends to the surface of the lens 30 are different. It is described that by adjusting the angle of this inclination, the distance from each light emitting end to the surface of the lens 30 can be matched with the focal length matching the wavelength of light.

However, there is a possibility that, when the light emitting surface is inclined, light may be reflected without being refracted depending on the angle, and the light may exit in an unintended direction. With this arrangement, there is a possibility that light utilization efficiency decreases.

On the other hand, in the present technology, the planar lightwave circuit 16 includes light emitting surfaces 1631 and 1632 including the light emitting ends 1621 and 1622 of each of the optical waveguides 1611 and 1612. Then, the light emitting surfaces 1631 and 1632 are formed in a direction substantially orthogonal to the optical axis direction of the emitted light. With this arrangement, since the emitted light can be reduced from traveling in an unintended direction, the light utilization efficiency is improved.

Further, the respective light emitting ends are formed on different planes. In this configuration example, the respective first light emitting end 1621 of the first optical waveguide 1611 and the second light emitting end 1622 of the second optical waveguide 1612 are formed on different planes. The first light emitting surface 1631 including the first light emitting end 1621 of the first optical waveguide 1611 is higher than the second light emitting surface 1632 including the second light emitting end 1622 of the second optical waveguide 1612. With this arrangement, an optical path difference occurs in each of the emitted light beams emitted from each of the first light source unit 111 and the second light source unit 112. Therefore, the divergence angles of the respective emitted light beams can be made different.

Note that in this configuration example, the light emitting surfaces 1631 and 1632 are formed in a stepwise shape, but the present technology is not limited to this shape. The first light emitting surface 1631 and the second light emitting surface 1632 may be connected by, for example, an inclined surface. Furthermore, in this configuration example, the number of steps is one, but a number of steps may be plural.

The above contents described for the image display device according to the third embodiment of the present technology can be applied to other embodiments of the present technology as long as there is no technical contradiction.

### 4. Fourth Embodiment of Present Technology (Example 4 of Image Display Device)

The wavelength bands of the emitted light beams emitted from each of the plurality of light source units 11 may be the same or different. A configuration example in a case where the wavelength bands are different will be described with reference to FIG. 7. FIG. 7 is a schematic diagram illustrating a configuration example of the light source units 11 according to one embodiment of the present technology.

As illustrated in FIG. 7, a plurality of light source units includes a first light source unit 111 that emits emitted light in a first wavelength band, a second light source unit 112 that emits emitted light in a second wavelength band, and a third light source unit 113 that emits emitted light in a third wavelength band. By appropriately adjusting each of the first wavelength band, the second wavelength band, and the third wavelength band, it is possible to allow the observer to visually recognize an image having high saturation, a wide dynamic range, and appropriate white balance.

More specifically, the first wavelength band may be a wavelength band corresponding to red, the second wavelength band may be a wavelength band corresponding to green, and the third wavelength band may be a wavelength band corresponding to blue. With this arrangement, the image display device 100 can allow the observer to visually recognize a full-color image. The wavelength band corresponding to red may be, for example, about 620 to 750 nm. The wavelength band corresponding to green may be, for example, about 500 to 550 nm. The wavelength band corresponding to blue may be, for example, about 430 to 500 nm.

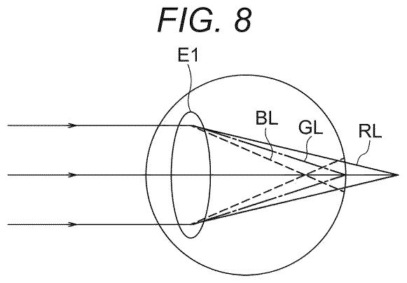

Further, it is preferable that the divergence angles of the respective emitted light beams are different according to the wavelength bands of the respective emitted light beams. This point will be described with reference to FIG. 8. FIG. 8 is a schematic diagram illustrating a state in which an image is formed on the retina of the observer.

As illustrated in FIG. 8, the position of the focus on the retina depends on a focal length of a crystalline lens E1 and a wavelength of light. For example, since blue light BL has a short wavelength, the blue light BL is more strongly refracted by the crystalline lens E1, and a focus is formed in front of the retina. Since red light RL has a long wavelength, the red light RL is weakly refracted by the crystalline lens E1, and a focus is formed at the back of the retina. Green light GL has a focus formed in the middle thereof.

Therefore, in order to form an image at an appropriate position on the retina, it is preferable that the divergence angles of the respective emitted light beams are different according to the wavelength bands of the respective emitted light beams. Referring again to FIG. 7, a divergence angle of emitted light emitted from the first light source unit 111 is preferably adjusted according to a wavelength band of the emitted light. Similarly, a divergence angle of emitted light emitted from the second light source unit 112 is preferably adjusted according to a wavelength band of the emitted light. A divergence angle of emitted light emitted from the third light source unit 113 is preferably adjusted according to a wavelength band of the emitted light. With this arrangement, it is possible to expand the free focus range while allowing the observer to visually recognize the image having the resolution as high as possible.

The above contents described for the image display device according to the fourth embodiment of the present technology can be applied to other embodiments of the present technology as long as there is no technical contradiction.

### 5. Fifth Embodiment of Present Technology (Example 5 of Image Display Device)

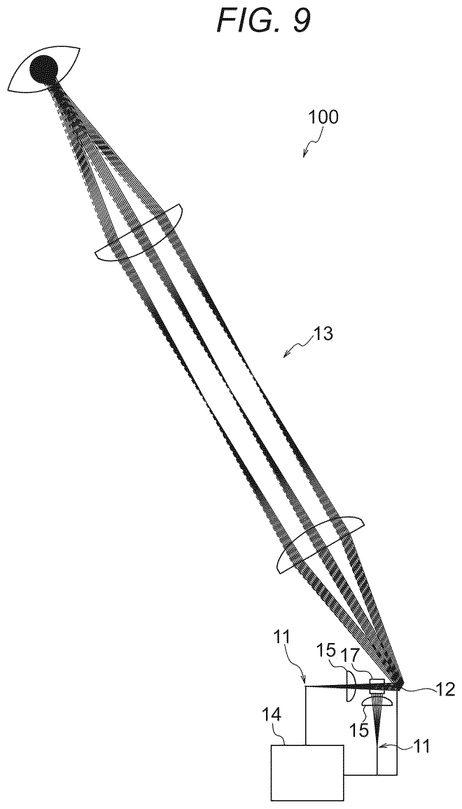

In order to increase a degree of freedom in designing the image display device 100, the image display device 100 may further include a multiplexing unit that multiplexes respective emitted light beams. This point will be described with reference to FIG. 9. FIG. 9 is a schematic diagram illustrating a configuration example of the image display device 100 according to one embodiment of the present technology.

As illustrated in FIG. 9, the image display device 100 further includes a multiplexing unit 17. The multiplexing unit 17 multiplexes respective emitted light beams emitted from the respective light source units 11 and emits the multiplexed light beams to the relay optical system 13.

With this arrangement, the degree of freedom in designing the image display device 100 increases. For example, as illustrated in FIG. 3, in a case where arrangement positions of the respective light source units 11 are different in an optical axis direction of the emitted light, when a distance between the respective light source units 11 becomes long, there is a possibility that the respective emitted light beams interfere with each other. On the other hand, in the configuration example illustrated in FIG. 9, the positions of the respective light source units 11 can be freely arranged, and the optical path difference between the respective emitted light beams can be generated.

Examples of the multiplexing unit 17 include a polarizing beam splitter (PBS), a polarization beam combiner (PBC), a half mirror, and an interference filter.

Note that also in the present embodiment, the number of light source units 11 is not particularly limited. In this configuration example, emitted light emitted from one light source unit 11 and emitted light emitted from one light source unit 11 are multiplexed by the multiplexing unit 17, but the number of light source units may be two or more.

The above contents described for the image display device according to the fifth embodiment of the present technology can be applied to other embodiments of the present technology as long as there is no technical contradiction.

### 6. Sixth Embodiment of Present Technology (Example 6 of Image Display Device)

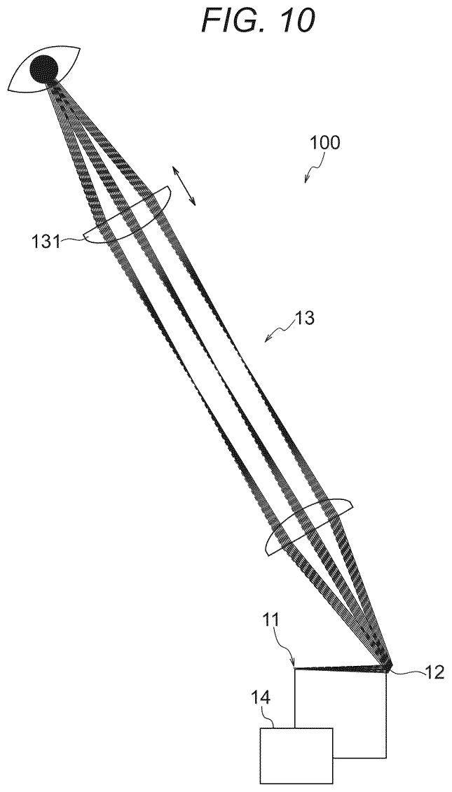

Instead of the adjustment unit 15 illustrated in FIG. 1 or in addition to the adjustment unit 15, for example, the relay optical system 13 may adjust a divergence angle. This point will be described with reference to FIG. 10. FIG. 10 is a schematic diagram illustrating a configuration example of the image display device 100 according to one embodiment of the present technology.

As illustrated in FIG. 10, in this configuration example, the relay optical system 13 includes an adjustment element 131 that adjusts a divergence angle of emitted light. The adjustment element 131 is movable on the basis of a display position of the image. A moving direction of the adjustment element 131 is not particularly limited, but for example, the adjustment element 131 may be movable in the arrow direction in the drawing.

The adjustment element 131 can be, for example, a convex lens having a characteristic of converging light. When the adjustment element 131 is a convex lens, the divergence angle increases as the adjustment element 131 moves away from the light source unit 11. Conversely, when the adjustment element 131 approaches the light source unit 11, the divergence angle decreases.

The adjustment element 131 can be, for example, a concave lens having a characteristic of diffusing light. When the adjustment element 131 is a concave lens, the divergence angle decreases as the adjustment element 131 moves away from the light source unit 11. Conversely, when the adjustment element 131 approaches the light source unit 11, the divergence angle increases.

The above contents described for the image display device according to the sixth embodiment of the present technology can be applied to other embodiments of the present technology as long as there is no technical contradiction.

### 7. Seventh Embodiment of Present Technology (Example 7 of Image Display Device)

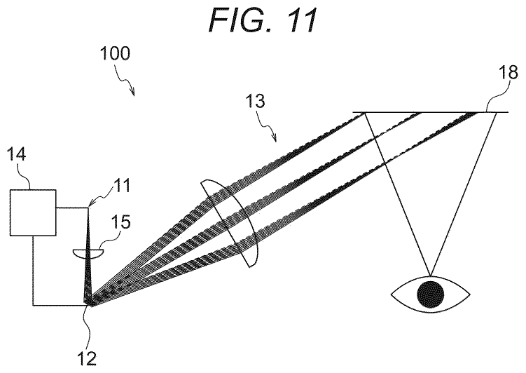

The image display device according to the present technology can be used for, for example, extended reality (XR) including augmented reality (AR) and virtual reality (VR). A configuration example of the image display device 100 that realizes the AR which is a technology of overlaying digital information on a real environment will be described with reference to FIG. 11. FIG. 11 is a schematic diagram illustrating a configuration example of the image display device 100 according to one embodiment of the present technology.

As illustrated in FIG. 11, the image display device 100 further includes an optical element 18 arranged in front of an eye of the observer. The optical element 18 transmits a part of light incident on the optical element 18, reflects a part of the light, and emits the light to the pupil of the observer. Since the optical element 18 has a transparent configuration, the observer can visually recognize the image generated by the image display device 100 while visually recognizing the real environment existing on the far side of the optical element 18.

Examples of the optical element 18 include a half mirror, a prism, a lens, an optical fiber, and a diffractive element. In particular, the optical element 18 may be, for example, a holographic optical element, a Fresnel lens, a reflective diffraction grating, a transmissive diffraction grating, or the like. The diffractive element may utilize the diffraction effect of light to diffuse or converge the light.

Since the optical element 18 is a diffractive element, for example, the image display device 100 can be simplified. Compared with other optical elements having a complicated optical configuration, such as a lens array, the diffractive element can realize simple and compact device design.

Furthermore, the diffractive element generally has a thin and lightweight structure. Therefore, it is suitable for the eyeglass-type image display device 100 in which wearing feeling and comfort are important factors.

Further, the diffractive element can provide high optical quality and resolution. Therefore, the image display device 100 can clearly display an image.

The above contents described for the image display device according to the seventh embodiment of the present technology can be applied to other embodiments of the present technology as long as there is no technical contradiction.

### 8. Eighth Embodiment of Present Technology (Example 8 of Image Display Device)

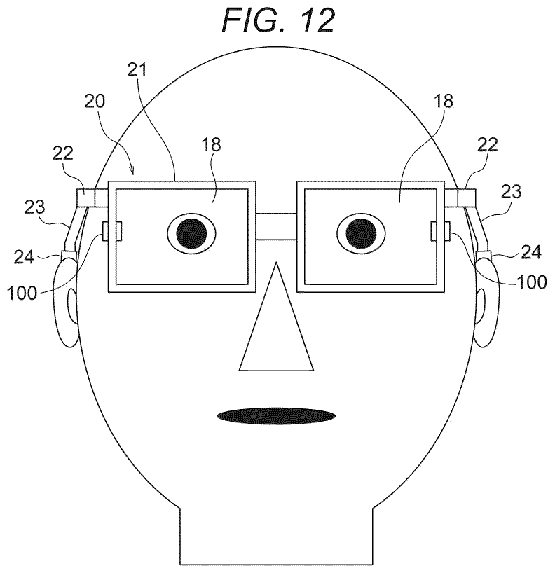

The image display device 100 according to the present technology can be worn on a head of the observer. This configuration example will be described with reference to FIG. 12. FIG. 12 is a schematic diagram of the observer wearing the image display device 100 according to one embodiment of the present technology on a head as viewed from the front.

As illustrated in FIG. 12, the image display device 100 can be worn on the head of the observer by, for example, a frame 20. The frame 20 includes front portions 21 arranged in front of the eyes of the observer, two temple portions 23 rotatably attached to both ends of the front portions 21 via hinges 22, and modern portions (also referred to as a tip cell, an ear pad, and an ear pad) 24 attached to distal end portions of the respective temple portions 23. The frame 20 may include metal or plastic.

The image display device 100 is arranged in a part of the front portion 21. The optical elements 18 according to the seventh embodiment are arranged in front of the observer's eyes by the front portions 21. Although not illustrated, the front portion 21 may include a nose pad. That is, the assembly of the frame 20 and the nose pad can basically have the structure substantially the same as that of the normal eyeglasses.

The above contents described for the image display device according to the eighth embodiment of the present technology can be applied to other embodiments of the present technology as long as there is no technical contradiction.

### 9. Ninth Embodiment of Present Technology (Example of Image Display Method)

The present technology provides an image display method of an image display device including a plurality of light source units; a scanning unit that scans each of emitted light beams emitted from each of the light source units; a relay optical system that relays the light beams scanned by the scanning unit to form an image on a retina of an observer and allows the observer to visually recognize the image; and a control unit that controls driving of each of the light source units, in which divergence angles of the respective emitted light beams are different. As this image display device, the image display devices according to other embodiments can be applied.

The above contents described for the image display method according to the ninth embodiment of the present technology can be applied to other embodiments of the present technology as long as there is no technical contradiction.

Note that embodiments according to the present technology are not limited to the respective embodiments described above, and various modifications can be made without departing from the gist of the present technology. The specific numerical values, shapes, materials (including compositions), and the like described in the respective embodiments are merely examples, and are not limited thereto.

Furthermore, the present technology may also adopt the following configurations.

[1]

An image display device including:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, in which
divergence angles of the respective emitted light beams are different.
   [2]

The image display device according to [1], in which
the control unit switches a free focus range by controlling the driving of each of the light source units on the basis of a display position of the image.
   [3]

The image display device according to [2], in which
the plurality of light source units includes at least a first light source unit, a second light source unit, and a third light source unit, and
when a first free focus range determined by the first light source unit and a second free focus range determined by the second light source unit are switched with a predetermined threshold,
a third free focus range determined by the third light source unit includes the predetermined threshold.
   [4]

The image display device according to any one of [1] to [3], in which
arrangement positions of the respective light source units are different.
   [5]

The image display device according to [4], in which
the arrangement positions of the respective light source units are different in an optical axis direction of the emitted light.
   [6]

The image display device according to any one of [1] to [5], further including:
an adjustment unit that adjusts the divergence angles of the emitted light beams and emits the emitted light beams to the relay optical system.
   [7]

The image display device according to any one of [1] to [6], in which
exit pupils of respective light beams incident on a pupil of the observer are substantially the same.
   [8]

The image display device according to any one of [1] to [7], further including:
a plurality of optical waveguides that guides the light beams emitted from the respective light source units.
   [9]

The image display device according to [8], in which
positions of light emitting ends of the respective optical waveguides are different in an optical axis direction of the emitted light.
   [10]

The image display device according to [9], in which
the plurality of optical waveguides is formed in a planar lightwave circuit,
the planar lightwave circuit has light emitting surfaces including the light emitting ends, and
the light emitting surfaces are formed in a direction substantially orthogonal to the optical axis direction of the emitted light, and the respective light emitting ends are formed on different planes.
   [11]

The image display device according to any one of [1] to [10], in which
the plurality of light source units includes:
a first light source unit that emits emitted light in a first wavelength band,
a second light source unit that emits emitted light in a second wavelength band, and
a third light source unit that emits emitted light in a third wavelength band.
   [12]

The image display device according to [11], in which
the first wavelength band is a wavelength band corresponding to red,
the second wavelength band is a wavelength band corresponding to green, and
the third wavelength band is a wavelength band corresponding to blue.
   [13]

The image display device according to any one of [1] to [12], in which
the divergence angles of the respective emitted light beams are different according to a wavelength band of each of the emitted light beams.
   [14]

The image display device according to any one of [1] to [13], further including:
a multiplexing unit that multiplexes the respective emitted light beams emitted from the respective light source units and emits the multiplexed light beams to the relay optical system.
   [15]

The image display device according to any one of [1] to [14], in which
the relay optical system includes an adjustment element that adjusts the divergence angle of the emitted light, and
the adjustment element is movable on the basis of a display position of the image.
   [16]

The image display device according to any one of [1] to [15], further including:
an optical element arranged in front of an eye of the observer, in which
the optical element transmits a part of light incident on the optical element, reflects a part of the light, and emits the light to a pupil of the observer.
   [17]

The image display device according to [16], in which
the optical element is a diffractive element.
   [18]

The image display device according to any one of [1] to [17], in which
the image display device is worn on a head of the observer.
   [19]

An image display method of an image display device including:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, in which
divergence angles of the respective emitted light beams are different.

### REFERENCE SIGNS LIST

100 Image display device
11 Light source unit
12 Scanning unit
13 Relay optical system
131 Adjustment element
14 Control unit
15 Adjustment unit
16 Planar lightwave circuit
161 Optical waveguide
162 Light emitting end
163 Light emitting surface
17 Multiplexing unit
18 Optical element
20 Frame
21 Front portion
22 Hinge
23 Temple portion
24 Modern portion

What is claimed is:

1. An image display device, comprising:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, wherein
divergence angles of the respective emitted light beams are different.

2. The image display device according to claim 1, wherein
the control unit switches a free focus range by controlling the driving of each of the light source units on a basis of a display position of the image.

3. The image display device according to claim 2, wherein
the plurality of light source units includes at least a first light source unit, a second light source unit, and a third light source unit, and
when a first free focus range determined by the first light source unit and a second free focus range determined by the second light source unit are switched with a predetermined threshold,
a third free focus range determined by the third light source unit includes the predetermined threshold.

4. The image display device according to claim 1, wherein
arrangement positions of the respective light source units are different.

5. The image display device according to claim 4, wherein
the arrangement positions of the respective light source units are different in an optical axis direction of the emitted light.

6. The image display device according to claim 1, further comprising:
an adjustment unit that adjusts the divergence angles of the emitted light beams and emits the emitted light beams to the relay optical system.

7. The image display device according to claim 1, wherein
exit pupils of respective light beams incident on a pupil of the observer are substantially the same.

8. The image display device according to claim 1, further comprising:
a plurality of optical waveguides that guides the light beams emitted from the respective light source units.

9. The image display device according to claim 8, wherein
positions of light emitting ends of the respective optical waveguides are different in an optical axis direction of the emitted light.

10. The image display device according to claim 9, wherein
the plurality of optical waveguides is formed in a planar lightwave circuit,
the planar lightwave circuit has light emitting surfaces including the light emitting ends, and
the light emitting surfaces are formed in a direction substantially orthogonal to the optical axis direction of the emitted light, and the respective light emitting ends are formed on different planes.

11. The image display device according to claim 1, wherein
the plurality of light source units includes:
a first light source unit that emits emitted light in a first wavelength band,
a second light source unit that emits emitted light in a second wavelength band, and
a third light source unit that emits emitted light in a third wavelength band.

12. The image display device according to claim 11, wherein
the first wavelength band is a wavelength band corresponding to red,
the second wavelength band is a wavelength band corresponding to green, and
the third wavelength band is a wavelength band corresponding to blue.

13. The image display device according to claim 1, wherein
the divergence angles of the respective emitted light beams are different according to a wavelength band of each of the emitted light beams.

14. The image display device according to claim 1, further comprising:
a multiplexing unit that multiplexes the respective emitted light beams emitted from the respective light source units and emits the multiplexed light beams to the relay optical system.

15. The image display device according to claim 1, wherein
the relay optical system includes an adjustment element that adjusts the divergence angle of the emitted light, and
the adjustment element is movable on a basis of a display position of the image.

16. The image display device according to claim 1, further comprising:
an optical element arranged in front of an eye of the observer, wherein
the optical element transmits a part of light incident on the optical element, reflects a part of the light, and emits the light to a pupil of the observer.

17. The image display device according to claim 16, wherein
the optical element is a diffractive element.

18. The image display device according to claim 1, wherein
the image display device is worn on a head of the observer.

19. An image display method of an image display device, including:
a plurality of light source units;
a scanning unit that scans each of emitted light beams emitted from each of the light source units;
a relay optical system that relays the light beams scanned by the scanning unit to form an image on a retina of an observer and allows the observer to visually recognize the image; and
a control unit that controls driving of each of the light source units, wherein
divergence angles of the respective emitted light beams are different.
